(19) United States
(12) Patent Application Publication
(10) Pub. No.: US 2025/0311676 A1
(43) Pub. Date: Oct. 9, 2025

(54) Separating System of a Combine Harvester with a Crop Flow Vane

(71) Applicant: AGCO Corporation, Duluth, GA (US)

(72) Inventors: Bernard Dean Regier, Hesston, KS (US); Tyler Thomas Gleason, Hesston, KS (US)

(21) Appl. No.: 19/172,270

(22) Filed: Apr. 7, 2025

Related U.S. Application Data
(60) Provisional application No. 63/631,528, filed on Apr. 9, 2024.

(51) Int. Cl. A01F 12/395

(52) U.S. Cl. CPC A01F 12/395

(57) ABSTRACT

A separating system of a combine harvester comprises a rotor, a cover extending around an upper region of the rotor and a separator grate extending around a lower region of the rotor. A crop flow vane extends along an internal face of the cover projecting towards the rotor. The crop flow vane comprises a head portion at which it is attached to the cover and a tail portion which is spaced from the cover to create a gap.

### CROSS-REFERENCE TO RELATED APPLICATIONS

This application claims the benefit of the filing date of U.S. Provisional Patent Application 63/631,528, “A Separating System of a Combine Harvester with a Crop Flow Vane,” filed Apr. 9, 2024, the entire disclosure of which is incorporated herein by reference.

### FIELD

Embodiments of the present disclosure relate generally to combine harvesters, and in particular to a crop flow vane used within the separating system of a combine harvester.

### BACKGROUND

A combine harvester typically includes a threshing system for detaching grains of cereal from material other than grain, such as cobs, stems and seed pods, a separating apparatus downstream of the threshing system, and a grain cleaning apparatus (known as the cleaning shoe) for receiving grain from the separating apparatus. A stratification pan aims to stratify the material into a layered structure of grain at the bottom and light chaff and other material other than grain (MOG) at the top. The grain is collected in a grain bin, and from the grain bin the grain can be unloaded, for example to a trailer pulled by a tractor which runs alongside the combine harvester.

The threshing apparatus and separating apparatus each comprise rotors which are housed within housings known as concaves for threshing and separator grates for separating. These components work together to separate the grain from the straw and chaff based on differences in size, weight, and aerodynamic properties. In this disclosure, they may each be considered to comprise parts of a separating system.

A crop flow vane (or separating vane) is often used within the separating apparatus. The crop flow vane is a narrow, curved metal plate or paddle positioned inside the combine harvester's separating mechanism. It is placed to guide the crop flow within the separating mechanism. As the mixture of grain, straw, and chaff moves through this area, the crop flow vane helps to direct the crop flow in such a way that the lighter straw and chaff are carried away, while the heavier grain falls through to be collected. The crop flow vane is for example mounted at the inside of a cover over the separating rotor. One or more crop flow vanes control the rate of throughput of crop material for a given rotor speed.

The position and angle of the crop flow vane can often be adjusted by the operator to optimize the separation process based on factors such as crop conditions, moisture content, and grain varieties. U.S. Pat. No. 9,282,696 discloses an adjustable crop flow vane.

The crop flow vane improves the efficiency of the combine harvester in separating the grain from the rest of the harvested crop, ensuring a high-quality yield while minimizing waste.

### BRIEF SUMMARY

The invention is defined by the claims.

According to examples in accordance with this disclosure, there is provided a separating apparatus of a combine harvester, comprising:
a rotor;
a cover extending partially around an upper region of the rotor;
a separator grate extending partially around a lower region of the rotor; and
a crop flow vane comprising a bar which extends adjacent an internal face of the cover projecting towards the rotor, wherein the crop flow vane comprises a head portion at which it is attached to the cover and a tail portion which is spaced from the cover to create a gap, wherein the gap has an average width in the range 5 mm to 25 mm and the gap is tapered, with increasing gap size towards the end of the tail portion that is remote from the head portion.

The gap improves the separation efficiency by allowing small grains to pass through the separator grate.

The crop flow vane may be used for part of the initial threshing function of a separating system or the later separating function of the separating system. Thus, the term “separating system” should be understood accordingly as covering either the typical threshing function or the typical separating function. Similarly, the separator grate may be for threshing or for subsequent separating.

If the gap width is non-uniform, the gap width may be taken to be the average gap width over the tail portion of the crop flow valve.

The gap width may be in the range 10 mm to 20 mm, for example the gap width may taper from a minimum in the range 5 mm to 15 mm to a maximum in the range 15 mm to 25 mm. For example, the gap width may taper from 13 mm to 20 mm.

The crop flow vane is attached to the inside of the top cover over a combine rotor. The vane is for example oriented in a way that encourages crop to index rearwardly on an axial combine. Since the trailing edge of the vane has a gap to the cover, grain and small mog can slip under the vane rather than follow the vanes. The larger MOG parts like the long straw continue to follow the vanes rearwardly. The grain that has slipped under the vane is allowed to exit the rotor cage through the separator grate without interference from the larger MOG. The vane also creates a barrier to protect the grain from the large MOG.

The crop flow vane for example has an adjustable orientation. Thus, it can be adjusted between more and less aggressive separating functions.

The head portion of the crop flow vane for example comprises a pivotal connection to the cover, wherein pivoting of the crop flow vane about the pivotal connection adjusts the location of the tail portion. The tail portion can for example be moved between two locations adjacent the internal surface of the cover. The two locations provide different paths for the larger MOG that strikes the crop flow vane.

The crop flow vane is for example adjustable between two orientations, each with a gap between the tail portion and the cover.

The gap is for example tapered, with increasing gap size toward the end of the tai portion. This provides a self-cleaning function, whereby material trapped in the gap is biased by the general flow conditions towards a larger gap size and hence released from the gap.

This disclosure also provides a combine harvester comprising:
a crop cutting head;
a separating system as defined above; and
a grain cleaning system.

The separating system may perform threshing and separating functions, or there may be a separate threshing system upstream of the separating system as defined above.

Within the scope of this application, it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of this disclosure will now be described, by way of example only, with reference to the accompanying drawings, in which:

FIG. 1 shows a combine harvester which may be adapted in accordance with this disclosure;

FIG. 2 shows one example of threshing system and grain cleaning apparatus in more detail;

FIG. 3 shows the rotor of an axial separating system in cross sectional view, with a crop flow vane;

FIG. 4 shows a view of the crop flow vane from beneath, in a first adjusted orientation;

FIG. 5 shows a view of the crop flow vane from beneath, in a second adjusted orientation; and

FIG. 6 shows another view of the crop flow vane.

### DETAILED DESCRIPTION

The subject matter of this disclosure will be described with reference to the Figures.

It should be understood that the detailed description and specific examples, while indicating exemplary embodiments of the apparatus, systems and methods, are intended for purposes of illustration only and are not intended to limit the scope of the disclosure. These and other features, aspects, and advantages of the apparatus, systems and methods of the present disclosure will become better understood from the following description, appended claims, and accompanying drawings. It should be understood that the Figures are merely schematic and are not drawn to scale. It should also be understood that the same reference numerals are used throughout the Figures to indicate the same or similar parts.

This disclosure provides a separating system of a combine harvester that comprises a rotor, a cover extending around an upper region of the rotor and a separator grate extending around a lower region of the rotor. A crop flow vane extends along an internal face of the cover projecting towards the rotor. The crop flow vane comprises a head portion at which it is attached to the cover and a tail portion which is spaced from the cover to create a gap.

This disclosure relates to the design of a separating system of a combine harvester, and in particular a crop flow vane used within such a separating system. However, a general outline of a combine harvester will first be provided.

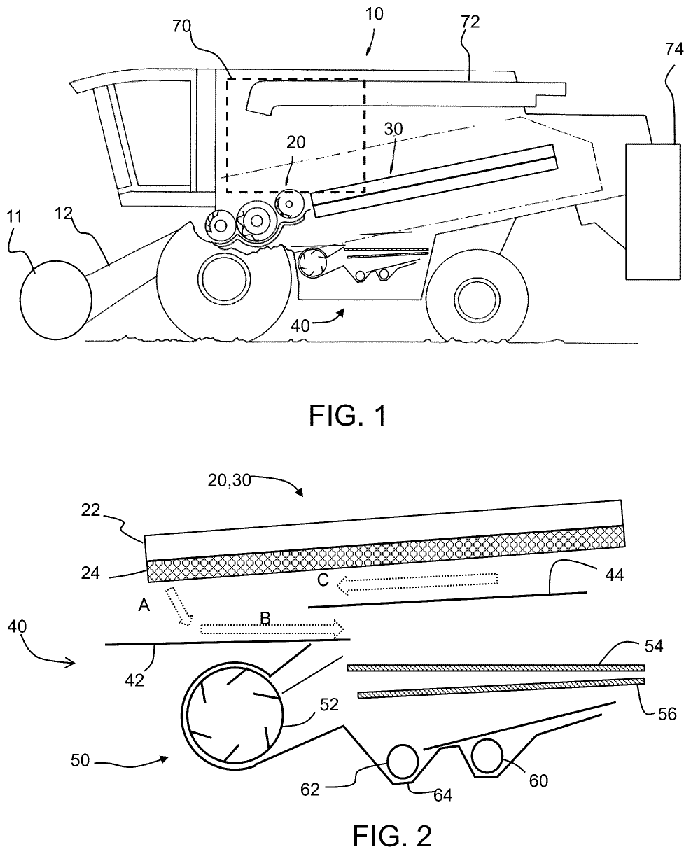

FIG. 1 shows a known combine harvester 10 to which the teachings of this disclosure may be applied. A crop cutting head 11 (known as the header) for example comprises a wide laterally extending transverse auger, which cuts the crop material and drives it inwardly towards a central area. A front elevator housing 12 receives the cut crop material and includes a feederhouse for transporting the crop material.

The feederhouse delivers the crop material to a threshing system 20 for detaching grains of cereal from the ears of cereal, and a separating apparatus 30 which is connected downstream of the threshing system 20. The threshing system comprises one or more threshing units, in particular rotors, and associated concaves.

In the example shown, the threshing system 20 is a tangential-flow ‘conventional’ threshing system, i.e. formed by rotating elements with an axis of rotation in the side-to-side direction of the combine harvester and for generating a tangential flow. For example, the ‘conventional’ threshing system includes a rotating, tangential-flow, threshing cylinder and a concave-shaped grate. The threshing cylinder includes rasp bars (not shown) which act upon the crop stream to thresh the grain or seeds from the remaining material, the majority of the threshed grain passing through the underlying grate and onto a stratification pan (also sometimes known as the grain pan).

The separating apparatus 30 in this example comprises an axial rotor (i.e. with an axis of rotation generally along the fore-aft direction of the combine, more specifically perpendicular to a lateral direction of the combine). FIG. 1 thus shows a so-called hybrid design, with tangential flow threshing and axial separation. The grains after separation by the separating device 30 pass to a grain cleaning apparatus 40.

The MOG (material other than grain), in particular chaff, exits the combine harvester at the back. A straw chopper may be provided at the back of the combine harvester. The straw chopper is used in combination with a straw spreader, and they are together represented as unit 74 in FIG. 1.

There are also axial threshing systems, i.e. formed by rotating elements with an axis of rotation in the longitudinal direction (direction of travel). For example, the threshing section may have axially-aligned rasp bars spaced around the front section whilst the separating section has separating elements or fingers arranged in a pattern, e.g. a spiral pattern, extending from the rasp bars to the rear of the rotor.

A combined axial threshing apparatus and separating apparatus 20,30 is shown in FIG. 2, together with a cleaning apparatus 40. The threshing apparatus and separating apparatus may each, or together, be considered to comprise a “separating system”.

The separating system 20,30 comprises an axial rotor 22 beneath which is mounted a separator arrangement 24. The separator arrangement 24 comprises a separator grate, such as a threshing concave section at a front portion and a separator grate section at a rear portion.

The threshing concave may have different section along its length, and the first section to receive the crop material (to the left in FIG. 2) may have a releasable concave, or else the whole length of the concave may be releasable. The separating function involves conveying the crop stream rearwardly in a ribbon passing along a spiral path over the separator grate section.

The initial threshing creates a flow of grain to a stratification pan 42. The separating function further downstream of the threshing and separating system serves to separate further grain from the crop stream and this separated grain passes through a grate-like structure onto an underlying return pan 44. The residue crop material, predominantly made up of straw, exits the machine at the rear.

The threshing and separating apparatus 20,30 may each or together be described as a separating system as explained above, in that they both separate grain from material other than grain, “MOG”. However, the separating system does not remove all MOG from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 is in the form of a grain cleaning unit 50. The grain cleaning unit 50 removes this unwanted material thus leaving a clean sample of grain to be delivered to the tank.

The grain cleaning unit 50 comprises a fan unit 52 and sieves 54 and 56. The upper sieve 54 is known as the chaffer.

The stratification pan 42 and return pan 44 are driven in an oscillating manner to convey the grain and MOG accordingly.

The general flow of material is as follows. The grain passing through the front portion of the separator arrangement 24 falls onto the front of stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the separator grate further back falls onto the return pan 44 and is conveyed forwardly by the oscillating motion and ridged construction thereof as shown by arrow C.

It is noted that “forwardly” and “rearwardly” refer to direction relative to the normal forward direction of travel of the combine harvester.

When the material reaches a front edge of the return pan 44 it falls onto the stratification pan 42 and is conveyed as indicated by arrow B.

The combined crop streams thus progress rearwardly towards a rear edge of the stratification pan 42. Whilst conveyed across the stratification pan 42, the crop stream, including grain and MOG, undergoes stratification wherein the heavier grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the heavier grain to pass through the chaffer onto an underlying second sieve 56.

The chaffer 54 is coarser (with larger holes) than second sieve 56. Grain passing through chaffer 54 is incident on the lower sieve 56 which is also driven in an oscillating manner and serves to remove tailings from the stream of grain before being conveyed to on-board tank (70 in FIG. 1) by grain collecting auger 62 which resides in a transverse trough 64 at the bottom of the grain cleaning unit 50. Tailings blocked by sieve 56 are conveyed rearwardly by the oscillating motion thereof to a rear edge from where the tailings are directed to the returns auger 60 for reprocessing in a known manner.

As explained above, it is known to provide a crop flow vane to direct the flow, particularly of MOG, through the separating system, and it is also known for the crop flow vane to be adjustable to provide different flow conditions, such as different flow rates.

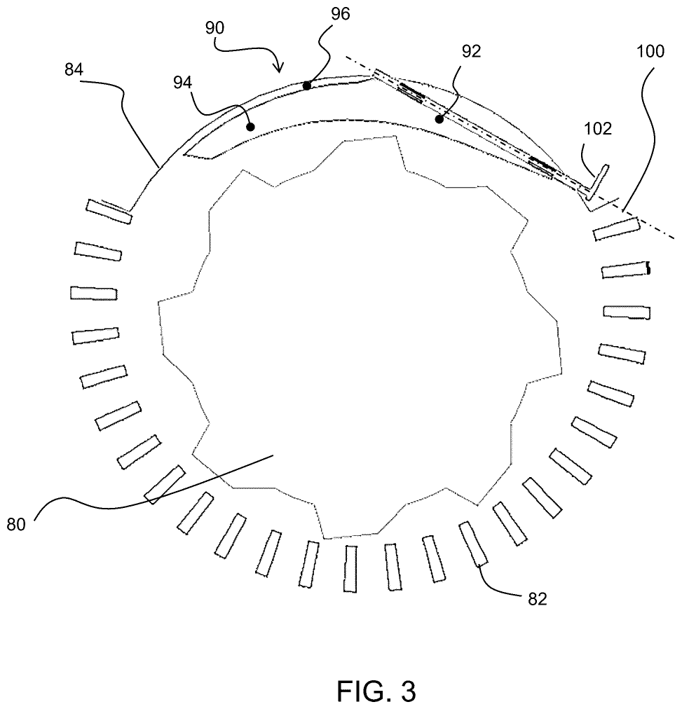

FIG. 3 shows a cross section through an axial rotor 80 (such as axial rotor 22), in particular at the separator section of the rotor. Beneath the rotor 80, at the rear separator end, is a separator grate 82 (forming part of the separator arrangement 24) and above the rotor is a cover 84. The cover 84 extends partially around an upper region of the rotor 80 and the separator grate 82 extends partially around a lower region of the rotor.

A crop flow vane 90 is attached to the cover. It comprises a bar which extends adjacent an internal face of the cover 84 projecting towards the rotor 80. The crop flow vane 90 comprises a head portion 92 at which it is attached to the cover 84 and a tail portion 94 which is spaced from the cover to create a gap 96.

In the example shown, the gap is a constant width along the length of the tail portion. The gap width is in the range 5 mm to 25 mm, for example 10 mm to 20 mm, for example it may be a constant gap width of 13 mm.

However, in another example, the gap has increasing width from the proximal end of the tail portion (where the tail portion connects to the head portion) and the distal free end of the tail portion.

The gap for example increases from a first width in the range 5 mm to 15 mm to a second width in the range 15 mm to 25 mm. For example, the gap width may taper from 13 mm to 20 mm, giving an average gap width of 16.5 mm (assuming a linear taper).

The tapered gap allows material to be released from the gap when it moves with the general flow conditions within the separating system. Thus, it prevents clogging of the gap. The crop flow vane follows the internal contour of the cover. It for example extends around an angle of between 50 and 150 degrees, for example between 70 and 110 degrees.

The crop flow vane is oriented in a way that encourages the crop material to index rearwardly (on an axial combine). The gap 96 enables small mog to slip under the vane rather than follow the vanes. The larger mog parts like the long straw continue to follow the vanes rearwardly. The grain that has slipped under the vane is allowed to exit the rotor cage through the separator grate 82 without interference from the larger mog. The vane also creates a barrier to protect the grain from the large mog.

FIG. 3 shows a pivot axis 100 about which the crop flow vane can be rotated by a handle 102. The axis 100 is generally tangential to the cover and rotation of the crop flow vane about the axis 100 changes the extent by which the crop flow vane extends axially (i.e. along the crop flow direction) along the cover. The crop flow vane thus can be moved between more and less aggressive separating orientations.

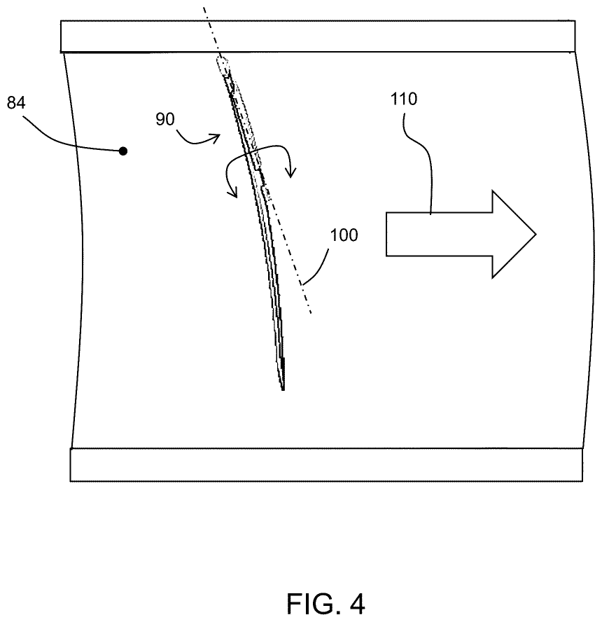

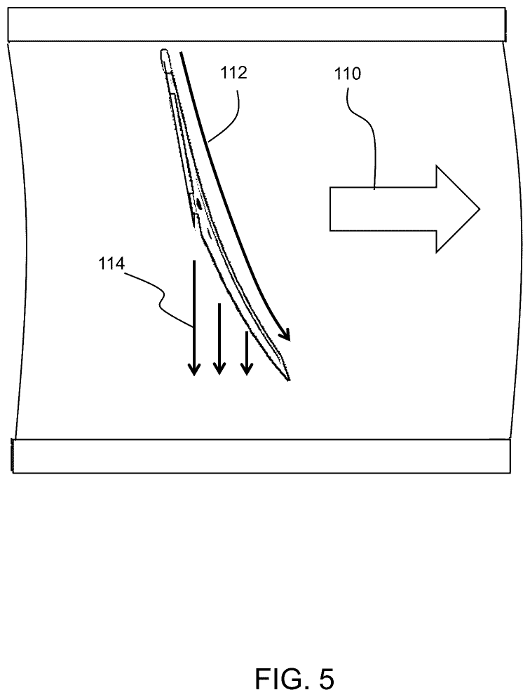

FIG. 4 shows a view of the crop flow vane from beneath (looking up at the inner face of the cover 84), in a first adjusted orientation. FIG. 5 shows a view of the crop flow vane from beneath, in a second adjusted orientation. In the second adjusted orientation, the crop flow vane is oriented with an increased forward directional component. As can be seen by comparing FIGS. 4 and 5, pivoting of the crop flow vane about the pivotal connection adjusts the location of the tail portion. The tail portion can for example be moved between two locations adjacent (but spaced from) the internal surface of the cover. The two locations provide different paths for the larger MOG that strikes the crop flow vane.

The flow direction of crop material is shown by arrows 110. FIG. 5 also shows the flow of large MOG as arrow 112 and the flow of seeds as arrow 114. These flows are generated by the rotation of the rotor within the cover and separator grate.

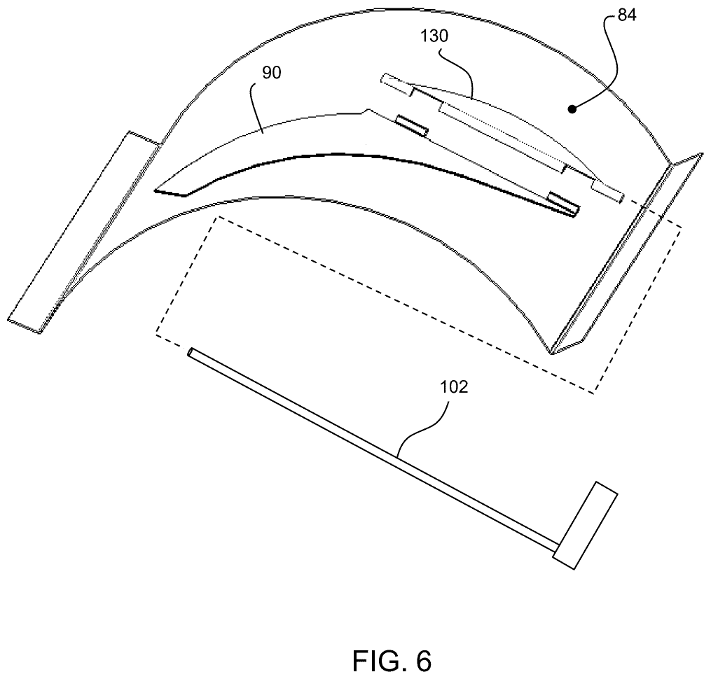

FIG. 6 shows another view of the crop flow vane, with the crop flow vane 90 detached from the hinge 130 and the handle 102 removed. The view is from above the cover 84, and the cover is illustrated as transparent to show the crop flow vane beneath.

The crop flow vane can be adjusted between the extreme positions and can be locked in the selected position. The shape of the crop flow vane and the design of the hinge about which it rotates is such that in all positions of the crop flow vane, the gap to the inner surface of the cover is maintained.

The teachings in this disclosure may be applied to any design of combine harvester in which the separating function has an axial flow of material along the rotation axis of the rotor. This rotor axis may be in the fore-aft direction of the combine harvester as shown in the examples above, but in a short wide combine design it may lie in a transverse direction across the width of the combine.

The hinge design shown above is only one possible implementation. Other hinge designs are possible, for example as disclosed in U.S. Pat. No. 9,282,696.

A single crop flow vane is described above. The cover may be provided with a line of crop flow vanes along the crop flow direction.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

Variations to the disclosed embodiments can be understood and effected by those skilled in the art in practicing the subject matter of this disclosure, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

Any reference signs in the claims should not be construed as limiting the scope.

All references cited herein are incorporated herein in their entireties. If there is a conflict between definitions herein and in an incorporated reference, the definition herein shall control.

What is claimed is:

1. A separating system of a combine harvester, comprising:
a rotor;
a cover extending partially around an upper region of the rotor;
a separator grate extending partially around a lower region of the rotor; and
a crop flow vane comprising a bar which extends adjacent an internal face of the cover projecting towards the rotor,
wherein the crop flow vane comprises a head portion at which it is attached to the cover and a tail portion which is spaced from the cover to create a gap, wherein the gap has an average width in the range 5 mm to 25 mm and the gap is tapered, with increasing gap size towards the end of the tail portion that is remote from the head portion.

2. The separating system of claim 1, wherein the crop flow vane has an adjustable orientation.

3. The separating system of claim 2, wherein the head portion of the crop flow vane comprises a pivotal connection to the cover, wherein pivoting of the crop flow vane about the pivotal connection adjusts the location of the tail portion.

4. The separating system of claim 3, wherein the crop flow vane is adjustable between two extreme orientations, each with a gap between the tail portion and the cover.

5. The separating system of claim 1, wherein the gap tapers from a minimum size in the range 5 mm to 15 mm to a maximum size in the range 15 mm to 25 mm.

6. A combine harvester comprising:
a crop cutting head;
a separating system as claimed in claim 1; and
a grain cleaning system.

7. The combine harvester of claim 6, wherein the threshing and separating systems together constitute an axial flow processing system.

8. The combine harvester of claim 8, wherein the axial flow processing system has an axis of rotation of the rotor in a fore-aft direction of the combine harvester.
